(19) United States
(12) Patent Application Publication
(10) Pub. No.: US 2015/0068969 A1
(43) Pub. Date: Mar. 12, 2015

(54) Mobile Fluid Clarifying System

(71) Applicants: Christopher H. Stagg, Cypress, TX (US); Jason L. Harmon, Lafayette, LA (US); Richard M. Seale, Houston, TX (US)

(72) Inventors: Christopher H. Stagg, Cypress, TX (US); Jason L. Harmon, Lafayette, LA (US); Richard M. Seale, Houston, TX (US)

(21) Appl. No.: 14/021,224

(22) Filed: Sep. 9, 2013

(51) Int. Cl. B01D 21/00

(52) U.S. Cl. CPC B01D 21/0045
USPC 210/322; 210/521

(57) ABSTRACT

Apparatus for removing solids from a liquid/solid mixture includes a plurality separation compartment formed by a plurality of weir partitions. According to one aspect of the invention, a lamella clarifier is positioned within one of the compartments. According to another aspect of the invention, a drain trough extends along the bottom of the apparatus and a plurality of drain pipes are connected to the trough. The drain pipes are connected to a common manifold pipe which in turn is connected to an inlet of a pump. The pump may be activated to remove separated solids that accumulate in the trough at the bottom of each compartment.

### BACKGROUND OF INVENTION

1. Field of the Invention

This application relates to a mobile apparatus for clarifying a liquid for example, water. This apparatus may be used to treat liquid flow back or liquid produced from an oil or gas well. It is specifically designed to remove solids from a liquid but may be used to separate any two components of varying density.

2. Description of Related Art

Currently, liquid clarifiers are in use that utilize various combinations of baffles and weirs as exemplified by U.S. Pat. No. 4,435,196 to Pielkenrood and U.S. Pat. No. 6,214,092 to Odom. Although somewhat effective, systems currently in use separate out a limited amount of solid from the mixture of liquids and solid. Also, it is difficult to effectively remove the solid material from the separation tank.

### BRIEF SUMMARY OF THE INVENTION

The present invention increases the amount of solids separated out from a liquid solid mixture by a unique combination of weir type compartments and a lamella clarifier. To enhance removal of solids from the bottom of the tank, the bottom portion of the tank includes sloping wall portions and a lower sump section with a plurality of drain pipes and valves. This arrangement facilitates removal of solids that have settled to the bottom of each compartment within the tank. The several drain pipes are connected to a common manifold pipe which in turn is connected to a single, specially selected pump for withdrawing the solids from the tank.

### BRIEF DESCRIPTION OF THE SEVERAL VIEWS OF THE DRAWING(S)

FIG. 1 is a rear prospective view of an embodiment of the invention.

FIG. 2 is a front perspective view of an embodiment of the invention.

FIG. 3 is a longitudinal cross-sectional view of the liquid tank.

FIG. 4 is a transverse cross-sectional view of the liquid tank.

FIG. 5 is a cross sectional view of the lamella clarifier section of the liquid tank.

### DETAILED DESCRIPTION OF THE INVENTION

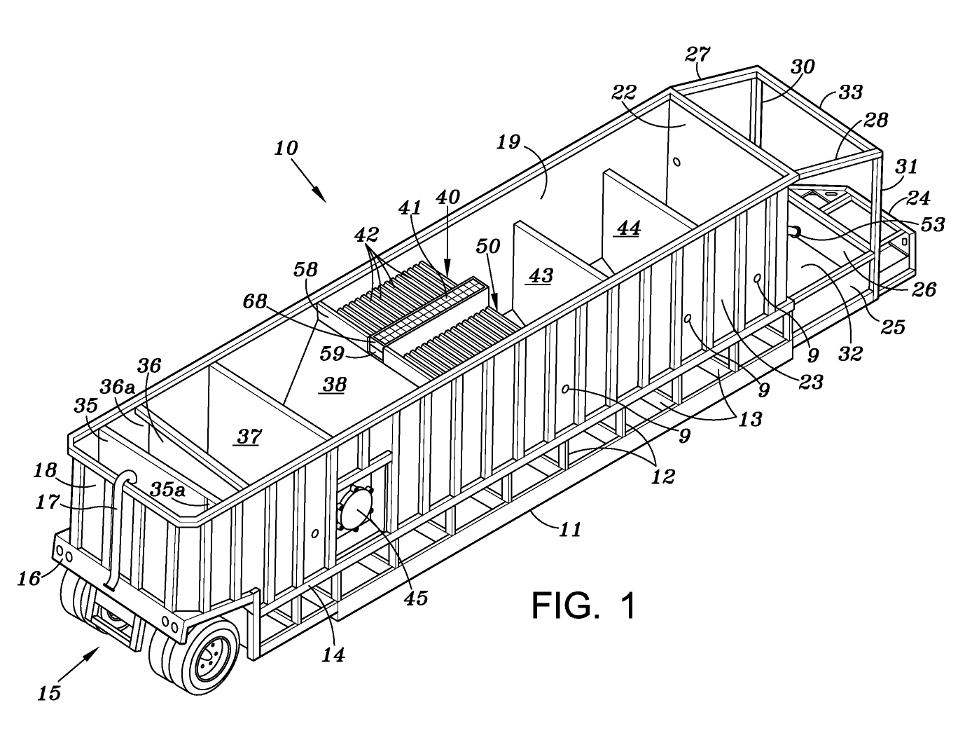

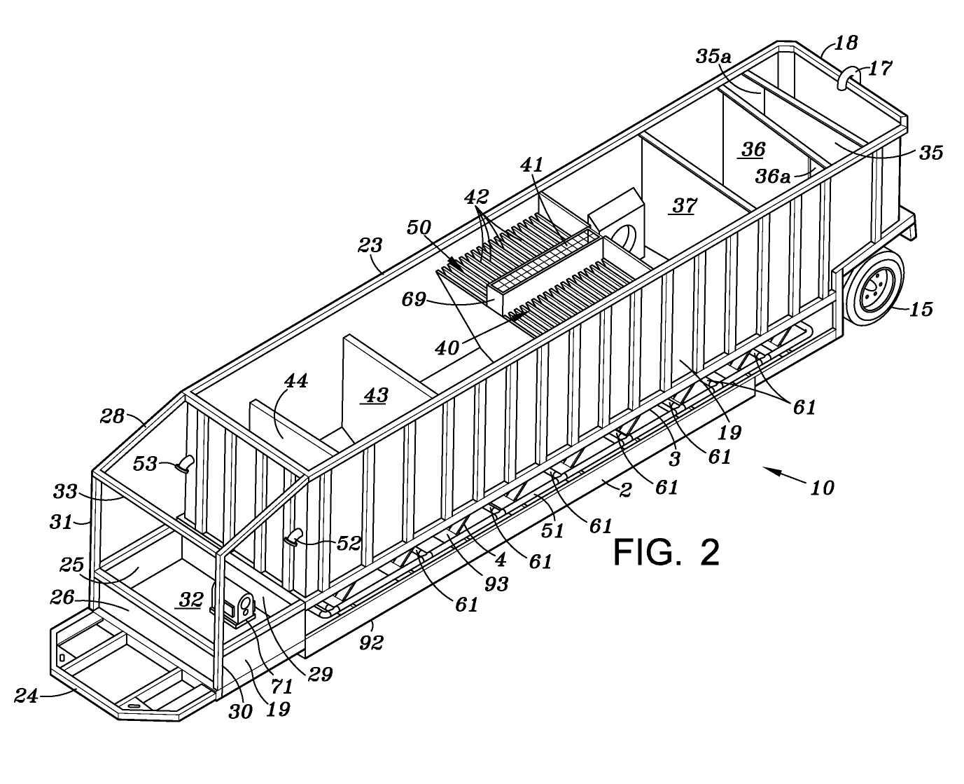

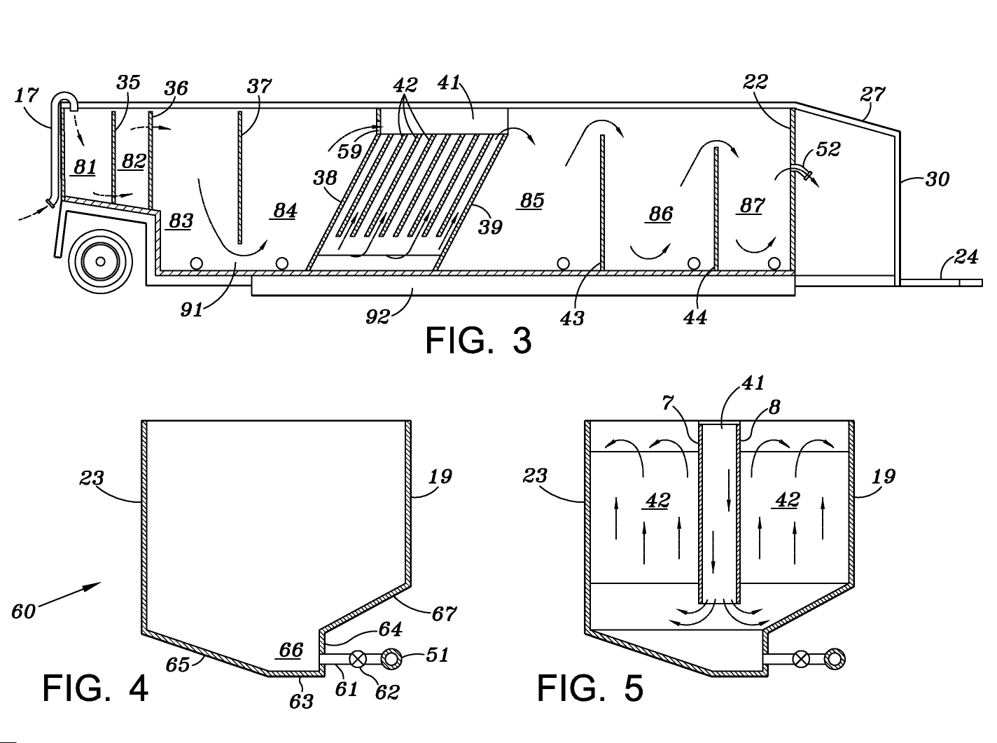

Referring to FIGS. 1 and 3, apparatus 10 according to an embodiment of the invention includes a tank 60 mounted on a wheeled frame assembly for ease of transportation. The frame includes longitudinal members 11 and 14 connected together by vertical struts 12. Struts 13 extend between longitudinal member 11 and tank 60 for support. The frame assembly also includes a longitudinal member 92 and support struts 93 and 4 as illustrated in FIG. 2. A platform comprising a floor 32, side walls 25, 26, 29 and 19 is connected to the frame and also to tank 60 via support frame 27, 28, 33, 30 and 31. A connector 24 for connecting the apparatus to a hauling vehicle extends forwardly of the platform. Connector may be designed for connection to the fifth wheel of a conventional truck or for connection to any known connection device. The rear portion of the apparatus is supported by wheel assembly 15. When the apparatus is disconnected from the truck, support frame member 2 and 11 rest on the ground.

Tank 60 is generally rectangular and includes front wall 22, rear wall 18 and side walls 19 and 23. As shown in FIG. 4, the bottom floor of tank 60 includes a first inclined section 65, a horizontal portion 63, and a vertical upright portion 64 which leads to a second inclined portion 67. This configuration forms a trough 66. A plurality of drain pipes 61 are in fluid communication with trough 66 through wall section 64. Each pipe 61 includes a valve 62. Each pipe 61 is connected to a manifold pipe 51 which in turn is connected to an inlet of a pump 71 which is mounted on platform floor 32. A manway 45 is provided through sidewall 23.

The interior structure of the tank which separates the liquid from the solid material will now be described with reference to FIG. 3. An inlet pipe 17 directs a fluid containing solid material into a first compartment 81 formed by end wall 18 and a side weir partition 35. An end portion of partition 35 is spaced from tank side wall 23 and forms an opening 35a so that the mixture of liquid and solids will flow around partition 35 and into a second compartment 82 formed between partition 35 and a second side weir partition 36. Second side weir partition is spaced from tank side wall 19 and forms an opening 36a so that the liquid solid mixture will flow around partition 36 into a third compartment 83 formed by second partition 36 and a third partition 37. Partition 37 extends between side walls 19 and 23 of the tank but is spaced from the floor of the tank to form a gap 91 for fluid flow. A fourth compartment 84 is formed between partition 37 and a fourth partition 38 which is inclined as shown in FIG. 3.

A central opening 59 is located at the top of partition 38 as shown in FIG. 1. Opening 59 leads into a center compartment 41 which extends between two lamella clarifiers 40 and 50 which include a plurality of spaced, parallel panels 42 which are inclined with respect to the horizontal. Panels 42 may be formed of high density polyethene. Center compartment 41 includes two side walls 7 and 8 and a front wall 69 and back wall 68 thus forming a box like structure that is open at the bottom as shown in FIG. 5. Inclined partitions 38 and 39 conform to the bottom of the tank 60 and together with side walls 19 and 23 form a closed chamber in which central compartment 41 and the lamella clarifiers are located. As shown in FIG. 5, fluid to be treated enters central compartment 41 through inlet 59 and flows downwardly and out the bottom of central compartment 41. From there, the fluid is directed upwardly along panels 42 where the solids continue to separate out. The liquid overflows partition 39 and falls into a fifth compartment 85 as shown in FIG. 3. Trough 41 may include an open grate covering its top portion. Fifth compartment 85 is formed between partition 39 and a partition 43 which is a top weir which allows fluid to flow over the top portion of partition 43 into a sixth compartment 86. Sixth compartment 86 is formed between partition 43 and a top weir partition 44 which allows fluid to flow over the top portion of weir 44. A final compartment 87 is formed between partition 44 and front wall 22. A pair of outlet pipes 52 and 53 are located at an upper portion of front wall 22 and permit clarified liquid to exit compartment 87. Partitions 43 and 44 conform to the shape of the bottom of the tank so as to form separate compartments that are closed at their bottoms.

As shown in FIG. 2, a drain pipe 61 is located in each compartment, 83-87 to provide an outlet for the solid material. Drain pipes 61 are connected to a common manifold pipe 51 which is connected to the inlet of pump 71. A plurality of sampling ports are provided in sidewall 23.

### MODE OF OPERATION

In operation, the liquid/solid mixture is introduced into the tank via inlet 17. The mixture is directed around partitions 35 and 36 into compartment 83. The mixture then exits chamber 83 where some of the solid material begins to fall to the bottom of the tank. Lighter oils accumulate at the top of chamber 83 and do not enter the rest of the tank. The mixture is then directed upwardly along baffle 38 to the opening 59 of center compartment 41. Fluid then flows out the bottom of center compartment 41 and is directed upwardly along the panels 42 of lamella clarifiers 40 and 50 where solids continue to fall to the bottom of the tank. The fluid passes over the top of partition 39 into compartment 85. The mixture then flows over weir 43 into chamber 86 and from there it travels over weir 44 into chamber 87 where further separation takes place. Clarified liquid exits the tank through outlets 52 and 53 from which the liquid may be directed to a storage tank or a further treatment device.

Solid material that settles to the bottom of the tank may be periodically removed by pump 71 via manifold pipe 51 and drain lines 61 that are connected to the bottom of the tank in the manner illustrated in FIG. 4. Pump 71 is preferably a rotary lobe positive displacement pump, although any fluid pump may be used. Although the drawings show a single drain pipe 61 connected to each of the compartments 83-87, more than one drain pipe can be connected to each compartment and the number of drain pipes could decrease as flow continues through the tank.

Although the present invention has been described with respect to specific details, it is not intended that such details should be regarded as limitations on the scope of the invention, except to the extent that they are included in the accompanying claims. For example the support frame for the tank 60 may be of any suitable design to support the tank on a wheeled support frame.

1. Apparatus for removing solids from a liquid/solid mixture comprising:
a tank having an inlet and an outlet;
a plurality of compartments formed by a plurality of weir partitions within the tank; and
a lamella clarifier positioned within the tank.

2. Apparatus according to claim 1 further including a center compartment positioned between two lamella clarifiers, the center compartment having an inlet for receiving the mixture and an open bottom for directing the mixture onto a plurality of panels of the lamella clarifiers.

3. Apparatus as claimed in claim 1 wherein said compartments include a first compartment and a second compartment separated by a side weir partition, said inlet directing fluid into said first compartment.

4. Apparatus according to claim 1 wherein said lamella clarifier comprises:
a plurality of spaced, parallel panels that are inclined with respect to the horizontal and are formed of high density polyethylene.

5. Apparatus according to claim 1 further including at least one drain pipe located at the bottom of each compartment, the drain pipes being connected to a common manifold pipe which is connected to an inlet of a pump.

6. Apparatus for removing solids from a liquid/solid mixture comprising:
a tank having an inlet and an outlet;
a plurality of liquid/solid separating compartments located within the tank;
said tank having two side walls and a bottom floor, said bottom floor including a first inclined portion extending downwardly from a first side wall of the tank, a generally horizontal portion, a vertically upright portion extending from the generally horizontal portion, and a second inclined portion extending to a second side wall portion from the vertically upright portion, thus forming a trough; and
at least one drain pipe extending from the trough in each compartment, the drain pipes being connected to a common manifold pipe.

7. Apparatus according to claim 6 further including a valve located in each drain pipe.

8. Apparatus according to claim 6 wherein the common manifold pipe is connected to an inlet of a pump, and the pump is a rotary lobe positive displacement pump.

9. The apparatus of claim 6 wherein each drain pipe is connected to the trough through the vertically upright portion of the bottom floor.
